(19) United States
(12) Patent Application Publication
(10) Pub. No.: US 2022/0292435 A1
(43) Pub. Date: Sep. 15, 2022

(54) Web-based outsourcing system

(71) Applicant: Yu-Hui Chen, Kaohsiung (TW)

(72) Inventor: Yu-Hui Chen, Kaohsiung (TW)

(21) Appl. No.: 17/804,004

(22) Filed: May 25, 2022

(51) Int. Cl. G06Q 10/06; G06Q 20/02; G06Q 50/18

(52) U.S. Cl. CPC G06Q 10/063118; G06Q 20/02; G06Q 50/182

(57) ABSTRACT

A web-based outsourcing system includes a central processing module, a membership module and a service module. The central processing module includes an operating unit connected to a database, a display unit connected to the database, and a processing unit connected to the database. The membership module is connected to the central processing module and includes an information module, a contract module and a financial module. The financial module is connected to the central processing module and includes a cash flow unit and a points unit. The service module is connected to the central processing module and the membership module respectively. The agent is allowed to use the service module by activating the service module to retrieve the job details and the job process provided by the appointing party or the appointed party so that the agent is allowed to use the job description for coordination, judgment and appeal.

### FIELD OF THE INVENTION

The invention relates to outsourcing and more particularly to a web-based outsourcing system for matching an appointing party (e.g., company) to an appointed party (e.g., job seeker).

### BACKGROUND OF THE INVENTION

Conventionally, an appointed party may go to an appointing party's office for interview. However, such job interviews are greatly decreased due to Covid-19. Instead, online interviews are gaining popularity. Thus, many outsourcing agencies transform its business model into web-based outsourcing agencies. In brief, every job opportunity is converted to a project mode which tailors the needs of a potential appointing party. A conventional web-based outsourcing system may provide a platform for matching an appointing party to an appointed party. After the agent has satisfied the appointed party's qualifications and the appointed party has agreed with the working conditions of the appointing party, a contract is signed by them.

However, the conventional web-based outsourcing system has the following drawbacks: there is no guarantee about the qualifications of the appointed party because the agent may speak too proudly about the appointed party's qualifications so that the agent can make money from the contract. There is no mechanism for solving contractual disputes (e.g., charge, incompetence of the appointed party) among the appointing party, the agent and the appointed party in the event of breach of contract.

Thus, the need for improvement still exists.

### SUMMARY OF THE INVENTION

It is therefore one object of the invention to provide a web-based outsourcing system comprising a central processing module, a membership module, and a service module wherein the central processing module includes a database, an operating unit connected to the database, a display unit connected to the database, and a processing unit connected to the database wherein the operating unit is configured to input personal information of an appointing party or an appointed party as a membership record and send the membership record to the database for storage; the database is configured to store profession descriptions and profession details, and store the membership record sent from the operating unit; the display unit is configured to display information stored in the database; and the processing unit is configured to fetch data from the database for analysis and send the analyzed data to the database for storage; the membership module is connected to the central processing module and includes an information module, a contract module, and a financial module wherein the information module is connected to the central processing module so that in response to an appointed party or an appointed party activating the information module to communicate with each other to enquire details of a job offered by the appointing party and a work experience by the appointed party, the information module processes the inquiry to find a match between the appointed party and the appointing party and stores the match in the database; the contract module is connected to the central processing module so that the processing unit is configured to retrieve the match from the database and the central processing module is configure to instruct the processing unit to send correspondence data of the appointing party to the contract module associated with the appointing party, and the contract module is configured to record job details and a job process between the appointed party and the appointing party and send the details of the job seeking process to the database for storage; the financial module is connected to the central processing module and includes a cash flow unit and a points unit wherein the cash flow unit is configured to allow a user to transfer money to a third party and receive money from the third party, after the user has used the cash flow unit for money transfer or money receiving, the processing unit calculates a total and sends same as cash flow information to the database for storage, the points unit is configured to fetch the cash flow information from the database and converts same to corresponding points, the appointing party or the appointed party pays money to a person or receive money from the third party based on the points, the points unit deducts used points from the total points to obtain remaining points and converts the remaining points to cash flow information which is sent to the processing unit, and the processing unit processes the cash flow information and sends the processed cash flow information to the database for storage; and the service module is connected to the central processing module and the membership module respectively and the agent is allowed to use the service module by activating the service module to retrieve the job details and the job process provided by the appointing party or the appointed party so that the agent is allowed to use the job description for coordination, judgment, and appeal, and the agent is allowed to provide support when there are contractual disputes between the appointing party and the appointed party.

The invention has the following advantages and benefits in comparison with the conventional art:

The created platform provides an opportunity of establishing a good relationship between the appointing party and the appointed party. A third party is charged with the tasks of communicating with both the appointing party and the appointed party so as to greatly decrease possible disputes.

Guarantee of job quality. The appointed party may activate the project module to ascertain whether he or she is qualified for the job after his or her qualifications and fees have been taken into consideration. As a result, job quality is guaranteed.

Correct job descriptions. The appointing party has to issue detailed job descriptions in advance as required by the contract module so that an appointed party can understand whether he or she is qualified for the job. As a result, the purpose of seeking a right person for a right job is achieved.

The web-based outsourcing system is project oriented. The appointing party (e.g., company) and the appointed party (e.g., job seeker) can communicate directly so that is highly free in choice and balanced. This is a great improvement in comparison with the conventional employment agency which matches employers to employees. But the employees have a lower freedom of choice.

The higher freedom of choice of the web-based outsourcing system means the appointed party can inquire about a number of jobs offered by the same appointing party or not. To the contrary, the appointing party can assign a number of jobs to the same appointed party or not.

With the higher freedom of choice, the following advantages are envisaged by the invention: Jobs of the project can be converted to job descriptions so that the appointing party can easily communicate with the appointed party about the job. Wages of the appointed parties can be classified into several levels based on ability of the appointed parties. The third party can record the job descriptions and arbitrate between the appointing party and the appointed party based on the record in the event of a breach of contract.

The above and other objects, features and advantages of the invention will become apparent from the following detailed description taken with the accompanying drawings

### BRIEF DESCRIPTION OF THE DRAWINGS

FIG. 1 is a block diagram of a web-based outsourcing system according to a first preferred embodiment of the invention;

FIG. 2 is a block diagram of a web-based outsourcing system according to a second preferred embodiment of the invention; and

FIG. 3 is a block diagram for showing a connection between an appointing party and an appointed party of the web-based outsourcing system.

### DETAILED DESCRIPTION OF THE INVENTION

In the invention, the appointing party is a company which is taken as an exemplary example in the following description, or an individual.

In the invention, the appointed party is a student seeking a part-time job, a salaried working seeking a part-time job, or a SOHO worker seeking a part-time job in the following description, or an individual.

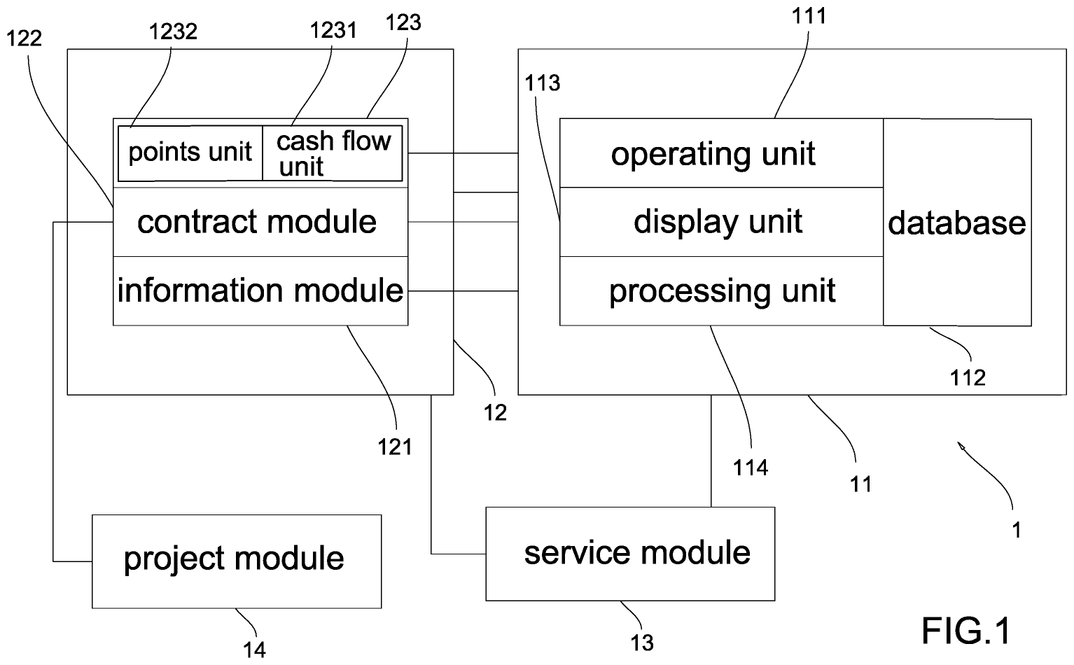

Referring to FIG. 1, a web-based outsourcing system 1 in accordance with a first preferred embodiment of the invention comprises a central processing module 11, a membership module 12 and a service module 13 as detailed below.

The central processing module 11 includes a database 112, an operating unit 111 connected to the database 112, a display unit 113 connected to the database 112, and a processing unit 114 connected to the database 112. The operating unit 111 is configured to input personal information of an appointed party as a membership record which is sent to the database 112 for storage.

The database 112 is configured to store profession descriptions and profession details, and store the membership record sent from the operating unit 111. The profession descriptions stored in the database 112 include webpage designer, advertising sales agent, editor, marketing specialist, translator, streamer, programmer, and artist. Salaries of the professions and wages of corresponding part time jobs are also stored in the database 112. Further, jobs for entry level, intermediate level and advanced level and their corresponding salaries are also stored in the database 112. The display unit 113 is configured to display information stored in the database 112 to be viewed by a user. The processing unit 114 is configured to fetch data from the database 112 for analysis and send the analyzed data to the database 112 for storage. The appointing party may activate the processing unit 111 to retrieve his or her personal data from the database 112 and analyze same to identify the corresponding membership which is shown on the display unit 113 for viewing.

The membership module 12 is connected to the central processing module 11 and includes an information module 121, a contract module 122 and a financial module 123. The information module 121 is connected to the central processing module 11. Finding a job using the invention, an appointed party may activate the information module 121 to communicate with an appointing party to enquire job details, job progress and job flow. The information module 121 processes the enquired data to find a match between the appointed party and the appointing party. The match is then stored in the database 112.

The contract module 122 is connected to the central processing module 11. The processing unit 114 may retrieve the match from the database 112 and the central processing module 11 may instruct the processing unit 114 to send correspondence data of the appointing party of the match to the contract module 122 associated with the appointed party. The contract module 122 records the job details and the job process between the appointed party and the appointing party and sends the job details and the job process to the database 112 for storage.

The financial module 123 is connected to the central processing module 11 and includes a cash flow unit 1231 and a points unit 1232. The cash flow unit 1231 is configured to allow a user to transfer money to a third party and receive money from the third party.

After the user has used the cash flow unit 1231 for money transfer or money receiving, the processing unit 114 calculates a total and sends same as cash flow information to the database 112 for storage. The points unit 1232 fetches the cash flow information from the database 112 and converts same to corresponding points. The appointed party may pay money to a person or receive money from the third party based on the points. Thereafter, the points unit 1232 deducts used points from the total points to obtain remaining points and converts the remaining points to cash flow information which is then sent to the processing unit 114. The processing unit 114 processes the cash flow information and sends the processed cash flow information to the database 112 for storage.

The service module 13 is connected to the central processing module 11 and the membership module 12 respectively and an agent may use the service module 13 for management. In detail, the agent may use the service module 13 to retrieve the job details and the job process provided by an appointing party so that the agent may use same for coordination, judgment, and appeal. The agent may provide support when there are contractual disputes between an appointing party and an appointed party.

The contract module 122 is connected to a project module 14. The appointed party may set at least one project module 14 based on need. The number of the project module 14 is decided by the appointed party. The contract module 122 provides details of selected jobs to the appointed party. Specifically, if more than two project modules 14 are used by the appointed party, the contract module 122 can be set to require the appointed party to pay a sufficient number of money (i.e., points) via the financial module 123 prior to executing the project modules 14. After the financial module 123 has received the payment from the appointed party, the financial module 123 notices the database 112 to update the membership of the appointed party. Thereafter, the agent can access the database 112 via the service module 13 to confirm the payment.

The number of the project module 14 can be set based on request from the appointed party. The contract module 122 can seek a job description based on needs from the appointed party. The contract module 122 can set an advancement payment method. Thus, the appointed party can set the number of the project module 15 based on its financial qualifications and needs so that an optimum amount of jobs can be provided any potential appointing party. It has the advantages of keeping a good communication between the appointing party and the appointed party and ensuring the agent to receive the payment in advance.

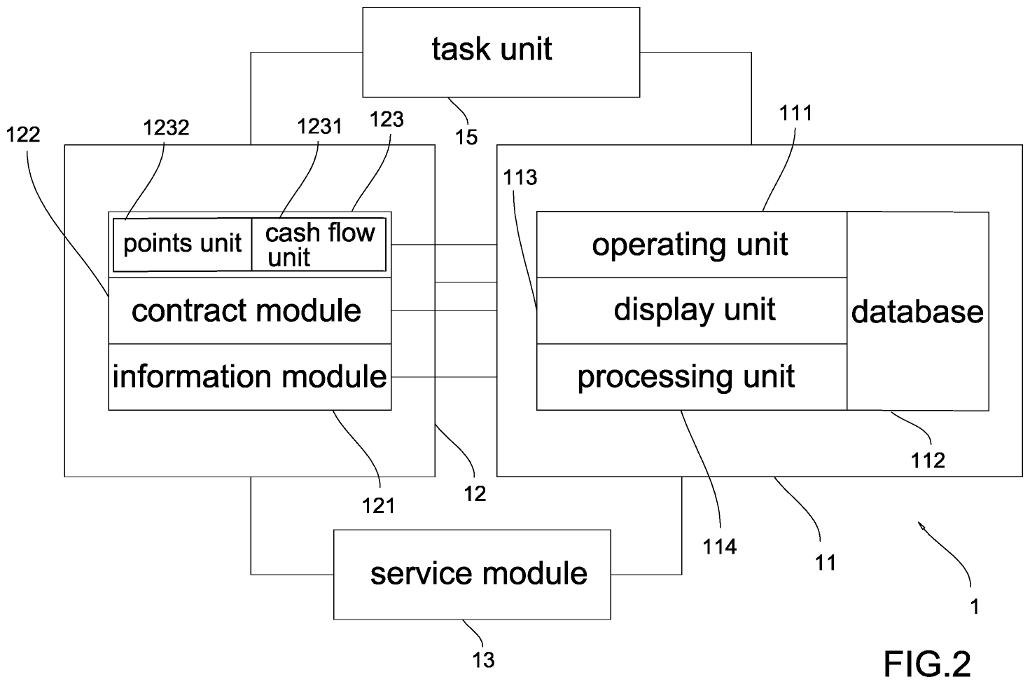

Referring to FIG. 2, a web-based outsourcing system 1 in accordance with a second preferred embodiment of the invention is shown. The characteristics of the second preferred embodiment are detailed below.

The central processing module 11 includes a database 112, an operating unit 111 connected to the database 112, a display unit 113 connected to the database 112, and a processing unit 114 connected to the database 112. The operating unit 111 is configured to input personal information of an appointing party as a membership record which is sent to the database 112 for storage. The database 112 is configured to store profession descriptions and profession details, and store the membership record sent from the operating unit 111. The profession descriptions stored in the database 112 include webpage designer, advertising agent, editor, marketing specialist, translator, streamer, programmer, and artist. Salaries of the professions and wages of corresponding part time jobs are also stored in the database 112. Further, jobs for entry level, intermediate level and advanced level and their corresponding salaries are also stored in the database 112. The display unit 113 is configured to display information stored in the database 112 to be viewed by a user. The processing unit 114 is configured to fetch data from the database 112 for analysis and send the analyzed data to the database 112 for storage. The appointing party may activate the processing unit 111 to retrieve his or her personal data from the database 112 and analyze same to identify the corresponding membership which is shown on the display unit 113 for viewing.

The membership module 12 is connected to the central processing module 11 and includes an information module 121, a contract module 122 and a financial module 123. The information module 121 is connected to the central processing module 11. Finding an employee using the invention, an appointing party may activate the information module 121 to communicate with an appointed party to enquire job details, job progress and job flow. The information module 121 processes the enquired data to find a match between the appointed party and the appointing party. The match is then stored in the database 112.

The contract module 122 is connected to the central processing module 11. The processing unit 114 may retrieve the match from the database 112 and the central processing module 11 may instruct the processing unit 114 to send correspondence data of the appointing party of the match to the contract module 122 associated with the appointing party. The contract module 122 records the job details and the job process between the appointed party and the appointing party and sends the details to the database 112 for storage.

The financial module 123 is connected to the central processing module 11 and includes a cash flow unit 1231 and a points unit 1232. The cash flow unit 1231 is configured to allow a user to transfer money to a third party and receive money from the third party. After the user has used the cash flow unit for money transfer or money receiving, the processing unit 114 calculates a total and sends same as cash flow information to the database 112 for storage. The points unit 1232 fetches the cash flow information from the database 112 and converts same to corresponding points. The appointing party may pay money to a person or receive money from the third party based on the points. Thereafter, the points unit 1232 deducts used points from the total points to obtain remaining points and converts the remaining points to cash flow information which is then sent to the processing unit 114. The processing unit 114 processes the cash flow information and sends the processed cash flow information to the database 112 for storage.

The service module 13 is connected to the central processing module 11 and the membership module 12 respectively and an agent may use the service module 13 for management. In detail, the agent may use the service module 13 to retrieve the job details and the job process provided by an appointing party so that the agent may use same for coordination, judgment, and appeal. The agent may provide support when there are contractual disputes between an appointing party and an appointed party.

A task unit 15 interconnects to the membership module 12 and the central processing module 11. The appointing party may use the task unit 15 to create a job description which is then sent to the display unit 13 to be viewed by the appointed party. Only the appointed party having the right of using the membership module 12 can see the job description.

In view of above, the web-based outsourcing system 1 of the invention quantizes many job opportunities and their descriptions and facilitates communication between the appointing party and the appointed party so that the appointing party can understand whether the appointed party has the qualifications of taking the job, and the appointed party can take an optimum number of jobs from the appointing party after taking salary and his or her qualifications into consideration.

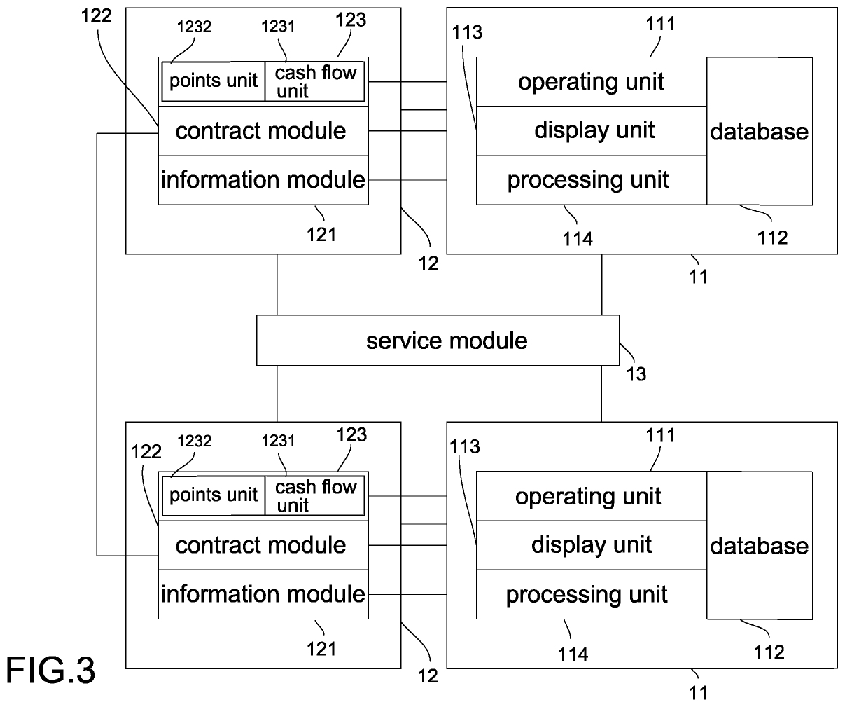

Referring to FIG. 3, it is a block diagram for showing a connection between an appointing party and an appointed party of the web-based outsourcing system. After a user (e.g., appointed party) has seen an interesting job description on the display unit 113 or a user (e.g., appointing party) has seen a description of qualifications of an appointed party on the display unit 113, the appointing party may contact the appointed party or the appointed party can contact the appointing party using the information module 121. Messages and/or pictures can be sent between them during the contact. After the appointing party has satisfied qualifications of the appointed party, the appointed party has understood the job description, and the appointed party has satisfied salary of the job, the contract module 122 can be activated so that the appointing party and the appointed party may sign a job contract. Further details of the job are recorded in the contract module 122. The service module 13 can be activated for arbitration including invoking the termination of convenience clause and refund in the event of a breach of contract. Thus, contractual disputes can be smoothly solved.

With respect to fund transfer from the appointing party to the appointed party, the points unit is used to manage the fund transfer. The processing unit may be activated per a predetermined period of time. The activated processing unit may calculate fund and update same. Finally, the financial unit may pay the appointing party and the appointed party based on the updated cash flow information.

In the event of two companies desiring to employ one appointed party and the appointed party having only one project module 14, a bidding can be conducted in due time and the appointing party giving the highest bid has the right to sign a contract with the appointed party.

The invention has the following characteristics and advantages:

The created platform provides an opportunity of establishing a good relationship between the appointing party and the appointed party. A third party is charged with the tasks of communicating with both the appointing party and the appointed party so as to greatly decrease possible disputes.

Guarantee of job quality. The appointed party may activate the project module to ascertain whether he or she is qualified for the job after his or her qualifications and fees have been taken into consideration. As a result, job quality is guaranteed.

Correct job descriptions. The appointing party has to issue detailed job descriptions in advance as required by the contract module so that an appointed party can understand whether he or she is qualified for the job. As a result, the purpose of seeking a right person for a right job is achieved.

The web-based outsourcing system is project oriented. The appointing party (e.g., company) and the appointed party (e.g., job seeker) can communicate directly so that is highly free in choice and balanced. This is a great improvement in comparison with the conventional employment agency which matches employers to employees. But the employees have a lower freedom of choice.

The higher freedom of choice of the web-based outsourcing system means the appointed party can inquire about a number of jobs offered by the same appointing party or not. To the contrary, the appointing party can assign a number of jobs to the same appointed party or not.

With the higher freedom of choice, the following advantages are envisaged by the invention: Jobs of the project can be converted to job descriptions so that the appointing party can easily communicate with the appointed party about the job. Wages of the appointed parties can be classified into several levels based on ability of the appointed parties. The third party can record the job descriptions and arbitrate between the appointing party and the appointed party based on the record in the event of a breach of contract.

While the invention has been described in terms of preferred embodiments, those skilled in the art will recognize that the invention can be practiced with modifications within the spirit and scope of the appended claims.

What is claimed is:

1. A web-based outsourcing system, comprising a central processing module, a membership module, and a service module wherein:
the central processing module includes a database, an operating unit connected to the database, a display unit connected to the database, and a processing unit connected to the database wherein the operating unit is configured to input personal information of an appointing party or an appointed party as a membership record and send the membership record to the database for storage; the database is configured to store profession descriptions and profession details, and store the membership record sent from the operating unit; the display unit is configured to display information stored in the database; and the processing unit is configured to fetch data from the database for analysis and send the analyzed data to the database for storage;
the membership module is connected to the central processing module and includes an information module, a contract module, and a financial module wherein the information module is connected to the central processing module so that in response to an appointed party or an appointed party activating the information module to communicate with each other to enquire details of a job offered by the appointing party and a work experience by the appointed party, the information module processes the inquiry to find a match between the appointed party and the appointing party and stores the match in the database;
the contract module is connected to the central processing module so that the processing unit is configured to retrieve the match from the database and the central processing module is configure to instruct the processing unit to send correspondence data of the appointing party to the contract module associated with the appointing party, and the contract module is configured to record job details and a job process between the appointed party and the appointing party and send the job details and the job process to the database for storage;
the financial module is connected to the central processing module and includes a cash flow unit and a points unit wherein the cash flow unit is configured to allow a user to transfer money to a third party and receive money from the third party, after the user has used the cash flow unit for money transfer or money receiving, the processing unit calculates a total and sends same as cash flow information to the database for storage, the points unit is configured to fetch the cash flow information from the database and converts same to corresponding points, the appointing party or the appointed party pays money to a person or receive money from the third party based on the points, the points unit deducts used points from the total points to obtain remaining points and converts the remaining points to cash flow information which is sent to the processing unit, and the processing unit processes the cash flow information and sends the processed cash flow information to the database for storage; and
the service module is connected to the central processing module and the membership module respectively and the agent is allowed to use the service module by activating the service module to retrieve the job details and the job process provided by the appointing party or the appointed party so that the agent is allowed to use the job description for coordination, judgment, and appeal, and the agent is allowed to provide support when there are contractual disputes between the appointing party and the appointed party.

2. The web-based outsourcing system of claim 1, further comprising at least one project module each connected to the contract module.

3. The web-based outsourcing system of claim 1, further comprising a task unit interconnected to the membership module and the central processing module for creating a job description.
